(19) United States
(12) Patent Application Publication
(10) Pub. No.: US 2017/0238598 A1
(43) Pub. Date: Aug. 24, 2017

(54) Measuring apparatus and measuring method for multi-segment rod-like articles of tobacco industry

(71) Applicant: International Tobacco Machinery Poland SP. Z O.O., Radom (PL)

(72) Inventor: Robert Stanikowski, Radom (PL)

(21) Appl. No.: 15/503,724

(22) PCT Filed: Sep. 11, 2015
(86) PCT No.: PCT/IB2015/056966

§ 371 Date: Feb. 14, 2017

(30) Foreign Application Priority Data
Sep. 12, 2014 (PL) P.409473

(51) Int. Cl. A24C 5/34; G06T 7/60; G06T 7/00; G01B 11/02; G01B 11/08

(52) U.S. Cl. CPC A24C 5/3412; G01B 11/02; G01B 11/08; G06T 7/0004; G06T 7/60; G06T 7/70

(57) ABSTRACT

The object of the application is a measuring method for geometrical parameters of a tobacco industry's multi-segment rod-like article (1, 1′, 1″), by means of a beam of electromagnetic radiation (6A) directed at the article (1, 1′, 1″), characterised in that by means of a radiation receiving device (7) a radiation (7A) emitted by the tobacco industry's multi-segment article (1, 1′, 1″) under the influence of excitation induced by the radiation (6A) directed at the tobacco industry's multi-segment article (1, 1′, 1″) is received, and a signal (32) corresponding to the received radiation (7 A) is generated. Furthermore, in the radiation receiving device (7) or using processing means (33) in the control system (30) of such device the signal (32) corresponding to the radiation (7A) received by the radiation receiving device (7) is processed and on the basis thereof an image (P, P′, P″) corresponding to the view of the multi-segment article (1, 1′, 1″) is created. Then, with the use of the processing means (33), based on the difference in intensity of the radiation (7A) emitted by the tobacco industry's multi-segment article (1, 1′, 1″) visible in the created image (P, P′, P″), the geometrical parameters of the article (1, 1′, 1″) are determined. Furthermore, with the use of the processing means (33), based on the position of geometric elements of the article (1, 1′, 1″) in the image (P, P′, P″), the geometrical parameters of the multi-segment article (1, 1′, 1″) are measured.

The object of the invention is a measuring apparatus and a measuring method for multi-segment rod-like articles tobacco industry.

In this document, the term of a multi-segment rod-like article of tobacco industry will be used. This term is meant to include any rod-like products and semi-finished products of the tobacco industry including multi-segment filter rods comprising filter segments, multi-segment filter rods comprising filter segments and additional components changing the article's aroma or giving such aroma, multi-segment filter rods comprising filter segments and additional objects changing the filter properties of filter materials used, multi-segment rods comprising both filter and non-filter segments, multi-segment articles with a reduced tobacco content as well as cigarettes with a single-segment or a multi-segment filter tip attached.

During the manufacturing process, the tobacco industry's multi-segment articles are subject to quality checks as semi-finished and finished products. The parameters checked include geometrical parameters comprising the length of individual segments, the length of entire article or semi-finished product, the diameter of article or semi-finished product, the dimensions of additional objects, the position of additional objects etc.

The US Patent Application Publication 200510054501A1 disclosed a measuring device designed to measure the properties of tobacco industry's articles, in particular finished cigarettes, based on the measurement of intensity of light reflected from an article or passing through an article, whereas the articles move crosswise relative to the axis of the articles on drum conveyors. The WO2012/130402A1 document presents a similar solution for articles moving in the axial direction. Both these solutions, however, do not ensure sufficient measurement accuracy due to possible interferences in the reception of reflected radiation.

The objective of this invention is to develop an improved measuring apparatus and measuring method.

The substance of the invention is a method for measuring geometrical parameters of a tobacco industry's multi-segment rod-like article, by means of a beam of electromagnetic radiation directed at the article. The method according to the invention is characterised in that the radiation emitted by a tobacco industry's multi-segment article under the influence of excitation induced by the radiation directed at the tobacco industry's multi-segment article is received by means of a radiation receiving device, and a signal corresponding to the received radiation is generated. Furthermore, in the radiation receiving device or using the processing means in the control system of such apparatus the signal corresponding to the radiation received by the radiation receiving device is converted, and on this basis an image corresponding to the view of the multi-segment article is created. Then, by means of the processing means the geometrical elements of the article are determined on the basis of the difference in the intensity of radiation emitted by a tobacco industry's multi-segment article visible in the created image. Furthermore, by means of the processing means the geometrical parameters of the multi-segment article are measured on the basis of the position of the article's geometric elements in the image.

Furthermore, the method according to the invention is characterised in that by means of the processing means the length and/or the diameter of a segment and/or a multi-segment article is measured on the basis of the position of the article's geometric elements in the image.

Furthermore, the method according to the invention is characterised in that the electromagnetic radiation directed at the article's surface is a radiation in the wavelength range between 100 nm and 1500 nm.

Furthermore, the method according to the invention is characterised in that the electromagnetic radiation directed at the article's surface is a radiation in the wavelength range between 300 and 400 nm.

Furthermore, the method according to the invention is characterised in that the electromagnetic radiation directed at the article's surface is a radiation in the wavelength range between 630 and 650 nm.

Furthermore, the method according to the invention is characterised in that the electromagnetic radiation is received in the wavelength range between 100 nm and 1500 nm.

Furthermore, the method according to the invention is characterised in that before the reception the radiation emitted by a multi-segment article is filtered by means of a filter transmitting a radiation band of the width corresponding to the wavelength band of electromagnetic radiation emitted by the multi-segment article.

Furthermore, the method according to the invention is characterised in that the electromagnetic radiation in the wavelength range between 440 nm and 450 nm is received.

Furthermore, the method according to the invention is characterised in that the electromagnetic radiation in the wavelength range between 680 nm and 690 nm is received.

Furthermore, the method according to the invention is characterised in that the electromagnetic radiation in the wavelength range between 730 nm and 740 nm is received.

Furthermore, the method according to the invention is characterised in that the electromagnetic radiation in the wavelength range between 720 nm and 1500 nm is received.

Furthermore, the method according to the invention is characterised in that the tobacco industry's multi-segment article comprises a segment containing a bead, and the geometrical parameter measured is the bead's position.

Furthermore, the method according to the invention is characterised in that the created image is a digital image, and the processing means are the means using a microprocessor and a digital image processing.

The solution according to the invention makes it possible to flexibly adjust the measuring apparatus to any geometrical parameters of products or semi-finished products. The manufacturer does not have to bear the costs of device replacement in case of a variation in manufactured products.

The object of the invention has been shown in embodiments in a drawing in which:

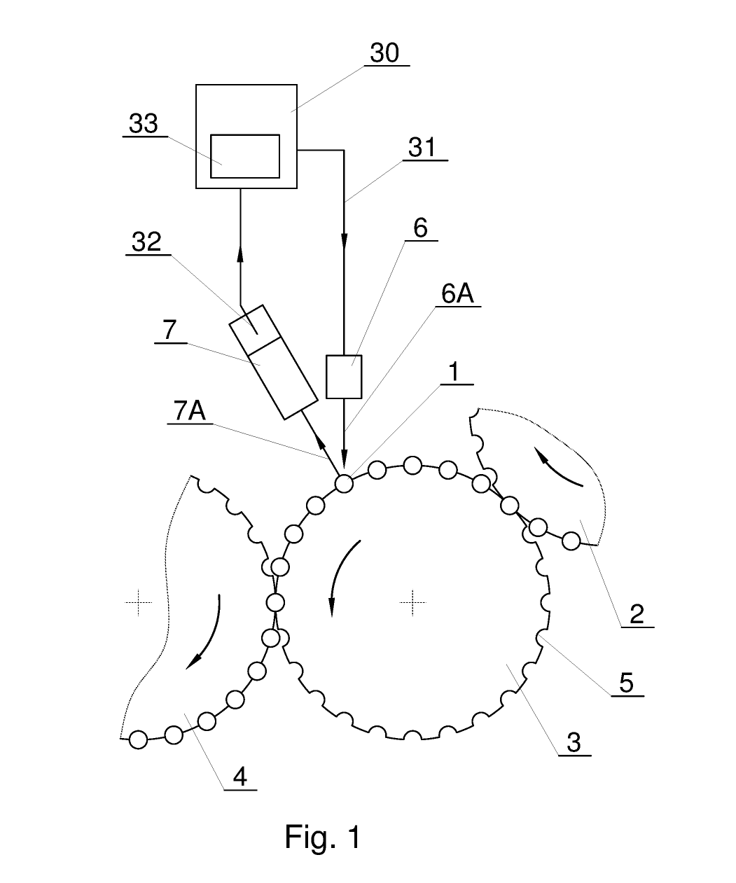

FIG. 1 shows a fragment of a machine comprising drum conveyors conveying multi-segment articles,

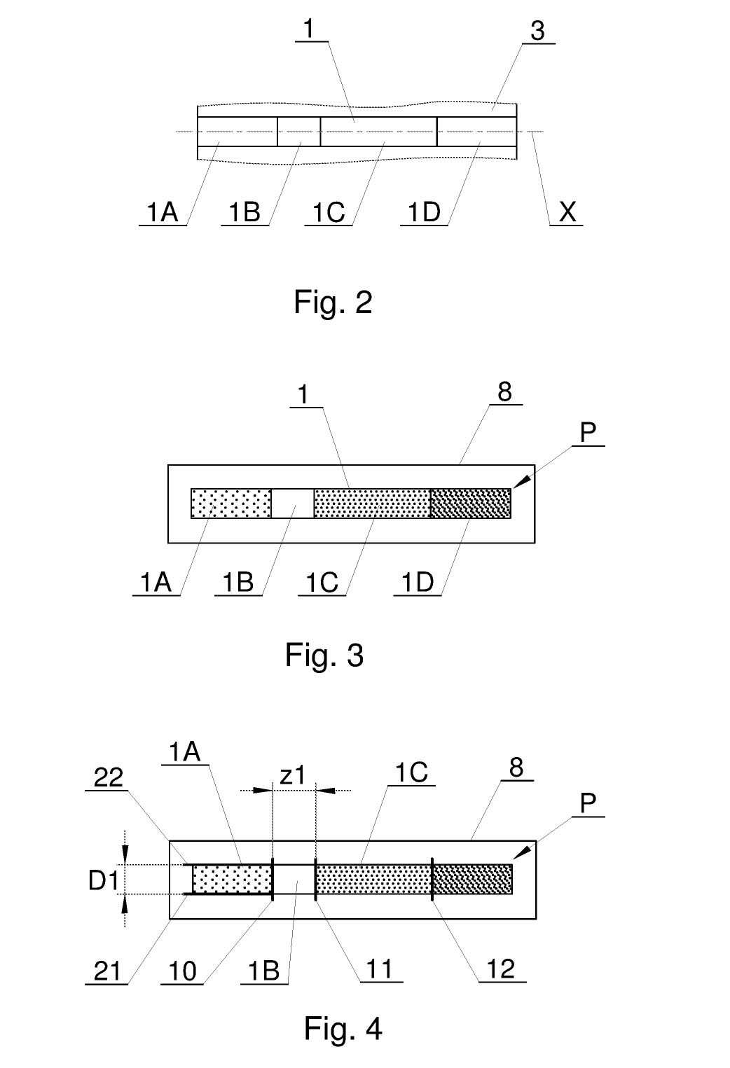

FIG. 2 shows a view of a multi-segment article on a drum conveyor,

FIGS. 3 and 4 show the field of view of the receiving device comprising the image of the article of FIG. 2,

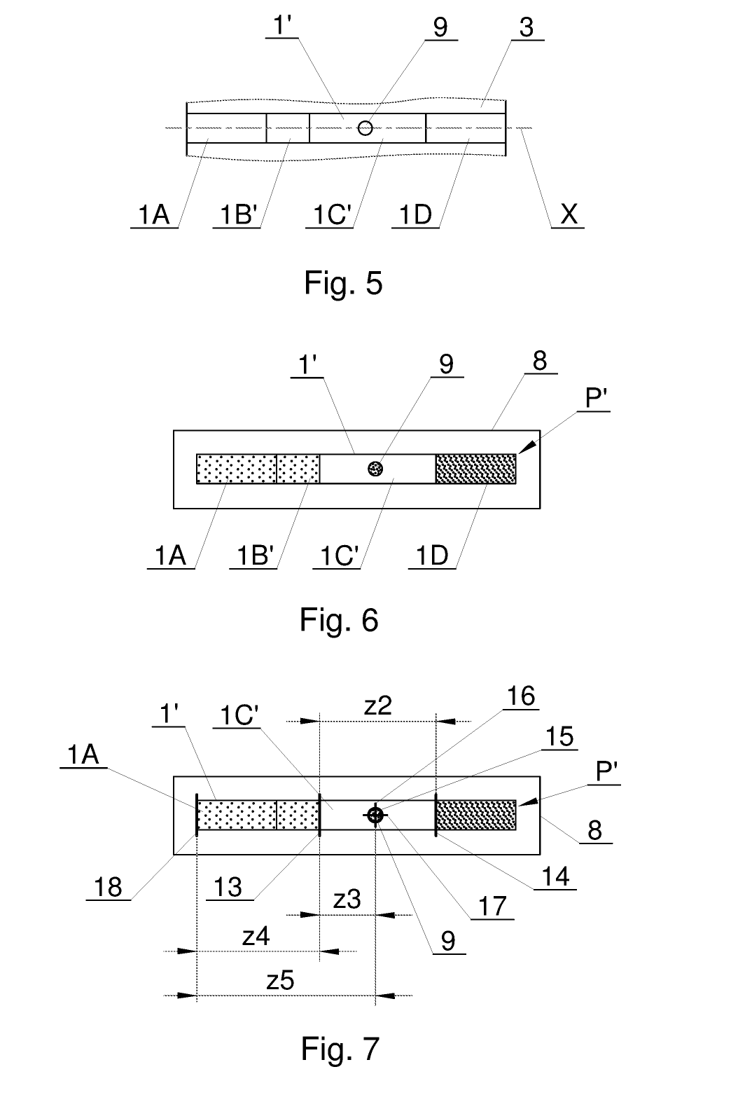

FIG. 5 shows a view of another multi-segment article on a drum conveyor,

FIGS. 6 and 7 show the field of view of the receiving device comprising the image of the article of FIG. 5,

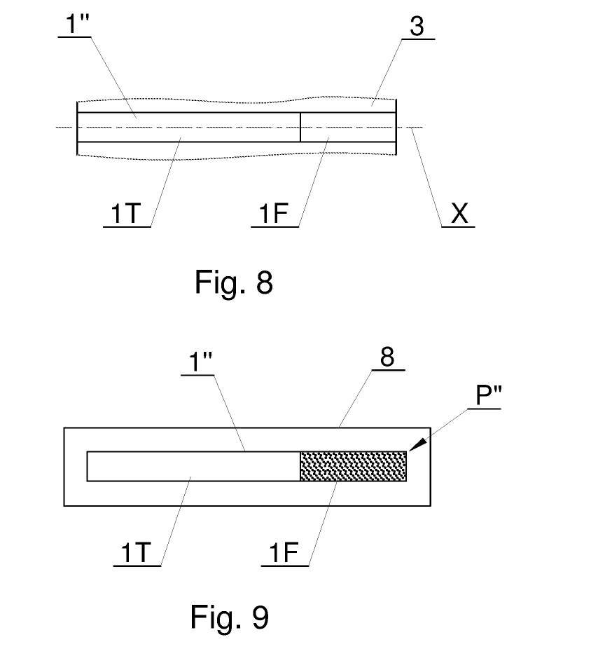

FIG. 8 shows a view of a cigarette on the drum conveyor,

FIG. 9 shows the field of view of the receiving device comprising the cigarette of FIG. 8.

The tobacco industry's multi-segment rod-like articles are usually conveyed crosswise to their axes, less frequently along their axes, whereas the article's quality check may take place in both cases. The articles may be conveyed crosswise to their axes on drum conveyors as well as on linear conveyors, such as belt or chain conveyors. FIG. 1 shows a fragment of a machine for conveying multi-segment articles 1 on drums 2, 3 and 4, whereas the articles 1 are conveyed in grooves 5 in which they are held by vacuum, usually with the use of several holes disposed along the grooves 5. A radiation source 6 situated at the drum 3 generates a beam of electromagnetic radiation marked as 6A directed at the lateral surface of the article 1, principally perpendicular to the axis X of the article 1, although it is possible to direct the beam of radiation at any angle to the axis X of the article 1, and even along this axis, both in case of conveying crosswise to the axis X and in the direction corresponding to the axis X. The applied radiation 6A may have a wavelength in both visible and invisible range. Certain materials used in the tobacco industry absorb the radiation and emit a radiation marked as 7A of a different wavelength the waves being recorded by the radiation receiving device 7, for example a camera.

Both the radiation source 6 and the radiation receiving device 7 are connected with the control system 30 controlling their operation by sending and receiving signals 31 and 32, respectively.

FIG. 2 shows a view of a multi-segment article 1 situated in the groove 5 of the drum 3, whereas it is shown as if the wrapping material or wrapping materials were transparent, and all constituent segments 1A, 1B, 10 and 1D are visible. Usually, in practice, individual constituent segments 1A, 1B, 10 and 1D are invisible from outside. The wrapping material or wrapping materials are at least partially translucent for both visible and invisible electromagnetic radiation. FIG. 3 shows the multi-segment article 1 as the radiation receiving device 7 “sees” it—the field of view 8 of the radiation receiving device 7 with the image P of the article 1 is shown, whereas it is a field of view in a direction which is principally perpendicular to the axis X of the article 1. The radiation receiving device may be directed at any angle to the axis X of the article 1, and even axially, depending on which part of the article is to be made visible. The radiation receiving device 7 records the radiation 7A emitted by the multi-segment article 1 as a result of excitation of the material molecules of segments of the article 1 by the radiation 6A. The areas of individual segments 1A, 1B, 10 and 1D which are dotted to a varying degree show different intensities of the radiation 7A emitted by the segments. The radiation receiving device (7) generates the signal 32 corresponding to the received radiation 7A and sends it to the control system 30. The radiation 7A may also be processed in the radiation receiving device 7A. The signal 32 may be processed using the processing means 33 of the control system 30.

The radiation 6A may be in the wavelength range between 100 nm and 1500 nm. In case of segments containing tobacco or processed tobacco it is advantageous to use the radiation with the wavelength range between 300 and 400 nm. It is also advantageous to use the radiation with the wavelength range between 630 nm and 650 nm. The emitted radiation 7A may be in the wavelength range between 100 nm and 1500 nm. The radiation 7A may consist of both the radiation emitted by the segments 1A, 1B, 10, 1D under the influence of the radiation 6A and of the radiation being the reflected radiation 6A. To avoid the interferences to the measurement, a filter with a pass band width corresponding to the band of electromagnetic radiation emitted by the article 1 may be used. Preferably, the radiation is received in the wavelength range between 440 nm and 450 nm, between 680 nm and 690 nm, between 730 nm and 740 nm and between 720 nm and 1500 nm.

FIG. 4 shows the same field of view 8 as shown in FIG. 3, whereas due to the recorded difference in radiation from the segments 1A, 1B, 10, 1D of the article 1, in the digital image recorded in the radiation receiving device or in the control system of such device the lines 10, 11 and 12 constituting delimiting lines between the segments 1A and 1B, 1B and 10, and 10 and 1D, respectively, have been marked. With the determined position of the delimiting lines 10 and 11 it is possible to accurately measure the distance z1 between such lines, i.e. between the segment edges being the length of the segment 1B. Likewise, the lines 21 and 22 limiting the segment 1A may be marked in a direction being perpendicular to the lines 10, 11. With the determined position of the lines 21 and 22 with the generating lines of the segment 1A, the diameter D1 of such segment may be measured. Known programmes for image processing constituting the processing means 33 may be used to mark the lines delimiting or limiting the outline of a segment or an entire article, and to process the image P itself.

FIG. 5 shows a view of a multi-segment article 1′ situated in the groove 5 of the drum 3, whereas it differs from the article 1 in that in the segment 10′ a bead 9, for example with an aromatic substance, is placed, and in addition the segments 1B′ and 10′ are made of a different material than the segments 1B and 10 of FIG. 2. Similar to the previous case, in the recorded digital image P′ of the article 1′, due to the existence of differences in intensity of the radiation 7A from individual segments and components of the article 1′, the lines 13 and 14 delimiting the segments 1B′ and 10′ as well as 10′ and 1D, respectively, based on which the length z2 of the segment 10′ may be determined, have been marked. Furthermore, the line 15 limiting the bead 9 has been marked; in this case the line is close to a circle, whereas additionally a vertical line 16 and a horizontal line 17 intersecting in the centre of the circle 15 were marked. With the determined centre of the circle 15 and position of the delimiting line 13 the distance from the centre of the bead 9 to the left edge of the segment 10′ marked as z3 may be determined. FIG. 7 also shows the line 18 limiting the segment 1A and the entire article 1′ on the left side, the marking of the line 18 allows determining both the distance z4, i.e. the position of the left edge of the segment 10′, and the distance z5, i.e. the position of the bead 9 from the left edge of the article 1′.

It is also possible to use the description of the measuring method to measure geometrical parameters of the wrapping material, for example the length of the paper wrapper of the filter or tobacco portion of the article may be measured. FIG. 8 shows the article 1″ in the form of a cigarette with a filter tip situated in the groove of the conveying drum 3, whereas a portion of the article wrapped with the wrapper of the filter tip 1F and a portion of the article wrapped with the wrapper of the tobacco portion 1T are visible. FIG. 9 shows the article of FIG. 8 in the form of an image P″ as it is visible to the radiation receiving device in the field of view 8, whereas similarly the difference in received radiation is marked by means of a dotted line.

1. A measuring method for geometrical parameters of a tobacco industry's multi-segment rod-like article (1, 1′, 1″) by means of a beam of electromagnetic radiation (6A) directed at the article (1,1′,1″), characterised in that
radiation (7A) emitted by the tobacco industry's multi-segment article (1, 1′, 1″) under the influence of excitation induced by the radiation (6A) directed at the tobacco industry's multi-segment article (1, 1′, 1″) is received by means of radiation receiving device (7), and a signal (32) corresponding to the received radiation (7A) is generated,
in the radiation receiving device (7) or by means of the processing means (33) in the control system (30) of such device the signal (32) corresponding to the radiation (7A) received by the radiation receiving device (7) is processed and on the basis thereof an image (P, P′, P″) corresponding to the view of the multisegment article (1, 1′, 1″) is created,
by means of the processing means (33) the geometric elements of the article (1, 1′, 1″) are determined on the basis of the difference in intensity of the radiation (7A) emitted by the tobacco industry's multi-segment article (1, 1′, 1″) being visible in the created image (P, P′, P″), after which
by means of the processing means (33) the geometrical parameters of the multisegment article (1, 1′, 1″) are measured on the basis of the position of geometric elements of the article (1, 1′, 1″) in the image (P, P′, P″).

2. A method as in claim 1 characterised in that by means of the processing means (33) the length and/or the diameter of the segment (1A, 1 B, 1 B′, 1C′, 1C, 1D, 1F, 1T) and/or the multi-segment article (1, 1′, 1″) is/are measured on the basis of the position of geometric elements of the article (1, 1′, 1″) in the image (P, P′, P″),.

3. A method as in claim 1 characterised in that the electromagnetic radiation (6A) directed at the surface of the article (1, 1′, 1″) is a radiation in the wavelength range between 100 nm and 1500 nm.

4. A method as in claim 1 characterised in that the electromagnetic radiation (6A) directed at the surface of the article (1, 1′, 1″) is a radiation in the wavelength range between 300 and 400 nm.

5. A method as in claim 1 characterised in that the electromagnetic radiation (6A) directed at the surface of the article (1, 1′, 1″) is a radiation in the wavelength range between 630 and 650 nm.

6. A method as in claim 1 characterised in that the electromagnetic radiation (7A) is received in the wavelength between 100 nm and 1500 nm.

7. A method as in claim 1 characterised in that before the reception the radiation (7 A) emitted by the multi-segment article (1, 1′, 1″) is filtered by means of a filter transmitting a radiation band of the width corresponding to the band of the waves of electromagnetic radiation (7A) emitted by the multi-segment article (1, 1′, 1″).

8. A method as in claim 6 characterised in that the electromagnetic radiation (7A) in the wavelength between 440 nm and 450 nm is received.

9. A method as in claim 6 characterised in that the electromagnetic radiation (7A) in the wavelength between 680 nm and 690 nm is received.

10. A method as in claim 6 characterised in that the electromagnetic radiation (7A) in the wavelength between 730 nm and 740 nm is received.

11. A method as in claim 6 characterised in that the electromagnetic radiation (7A) in the wavelength between 720 nm and 1500 nm is received.

12. A method as in claim 1 characterised in that the tobacco industry's multi-segment article (1, 1′, 1″) comprises a segment (1C′) containing a bead (9), and the geometrical parameter measured is the position of the bead.

13. A method as in claim 1 characterised in that the created image (P, P′, P″) is a digital image, and the processing means (33) are means using a microprocessor and a digital image processing.
